(19) United States
(12) Patent Application Publication
(10) Pub. No.: US 2007/0072495 A1
(43) Pub. Date: Mar. 29, 2007

(54) Male terminal fitting and blank therefor

(75) Inventors: Keiichi Nakamura, Yokkaichi-City (JP); Ryotaro Ishikawa, Yokkaichi-City (JP); Yutaka Noro, Yokkaichi-City (JP); Yutaka Kobayashi, Yokkaichi-City (JP); Hajime Kawase, Yokkaichi-City (JP)

Correspondence Address: CASELLA & HESPOS, 274 MADISON AVENUE, NEW YORK, NY, 10016, US

(73) Assignee: Sumitomo Wiring Systems, Ltd., Yokkaichi-City (JP)

(21) Appl. No.: 11/604,983

(22) Filed: Nov. 28, 2006

Related U.S. Application Data
(62) Division of application No. 11/344,649, filed on Feb. 1, 2006.

(30) Foreign Application Priority Data
Feb. 2, 2005 (JP) 2005-026667

(51) Int. Cl. H01R 4/18

(52) U.S. Cl. 439/866

(57) ABSTRACT

A male terminal fitting (1) is formed by bending a flat metal plate worked into a specified shape and includes a contact (2), a rectangular tube (4) formed to be wider than the contact (2), and a link (3) between the contact (2) and the rectangular tube (4). The link (3) is not connected with the front edge of the upper surface of the rectangular tube (4) over the entire width. Thus, bending resistance against an external force can be improved by increasing deflectability while holding down bending rigidity.

This application is a divisional of U.S. patent application Ser. No. 11/344,649, filed on Feb. 1, 2006.

### BACKGROUND OF THE INVENTION

1. Field of the Invention

The invention relates to a male terminal fitting and a blank therefor.

2. Description of the Related Art

U.S. Pat. No. 5,649,842 and FIG. 9 herein disclose a male terminal fitting. With reference to FIG. 9, the male terminal fitting is identified generally the numeral 100 and has a terminal contact portion 101 for connection with a female terminal fitting. A link 102 is rearward of the terminal contact portion 101 and a rectangular tube 103 extends rearward from the link 102. A barrel 104 is at the rear end of the male terminal fitting 100 and is configured for connection with a wire W (not shown).

An external force can act on the terminal contact portion 101 and can concentrate stress on a boundary between the link 102 and the terminal contact portion 102, thereby causing a bend beyond a resiliency limit at this boundary.

The present invention was developed in view of this problem and an object thereof is to increase the bending resistance of a male terminal fitting.

### SUMMARY OF THE INVENTION

The invention relates to a male terminal fitting with opposite front and rear ends. A contact is disposed at the front end and is configured for contact with a female terminal fitting. A tube is behind the contact and is wider than the contact. A link is provided between the tube and the contact and gradually widens from the contact toward the tube. The link includes a base wall, first and second side walls that extend from the base wall and a ceiling that extends from one of the first side wall. The base wall, the side walls and the ceiling are substantially continuous with the contact and the tube. However, the ceiling of the link does not extend the full width of the tube, and an unconnected edge extends across part of the front of the tube. Accordingly, bending rigidity is lower as compared to a case where the ceiling and the tube are connected over the entire width of the tube. Thus, the contact and of the link are more deflectable in response to external forces on the contact.

The tube preferably includes an engaging portion that is engageable with a lock formed in a cavity of a connector housing when the male terminal fitting is accommodated into the cavity.

The ceiling preferably is bent from the first side wall towards the second side wall or the base wall.

The ceiling preferably has substantially the same width as the contact, and the rear of the ceiling is connected with part of the front of an upper wall of the tube.

An opening preferably is defined adjacent to the unconnected edge, and the male terminal fitting is formed with a closing plate for at least partly closing the opening. Accordingly, external matter or the like cannot intrude into the link or the rectangular tube.

The contact preferably is formed from two or more plates folded to be placed at least partly on one another.

The invention also relates to a blank for forming a male terminal fitting. The blank has an area for forming a contact for contacting a female terminal fitting, an area for forming a tube behind the contact and wider than the contact, and an area for forming a link between the tube and the contact and gradually widened from the contact towards the tube. The area for the link has a base panel continuous with the contact and the tube, side panels continuous with the contact portion and the tube and extending from opposite sides of the base panel, and a ceiling panel substantially continuous with the contact and the tube. An unconnected edge is formed at the front of the tube and is unconnected with the ceiling panel.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a right side view of a male terminal fitting according to a first embodiment.

FIG. 2 is a plan view of the male terminal fitting.

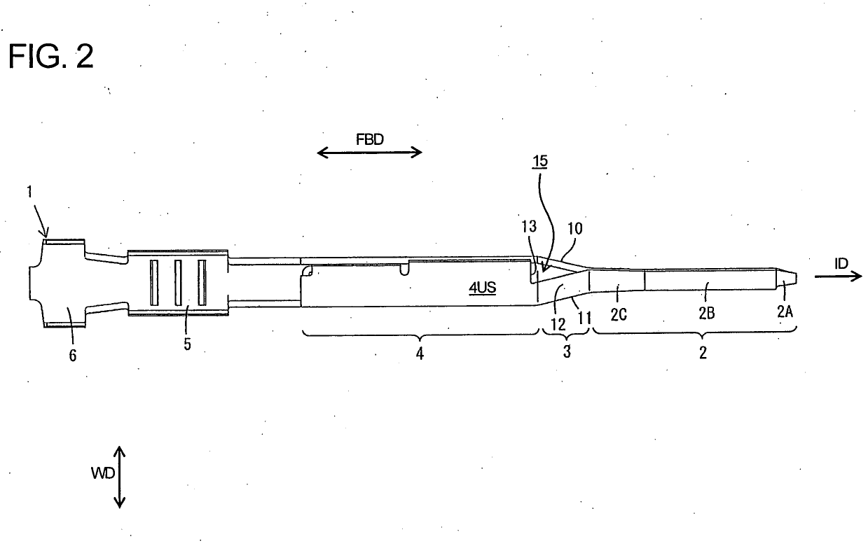

FIG. 3 is a left side view of the male terminal fitting.

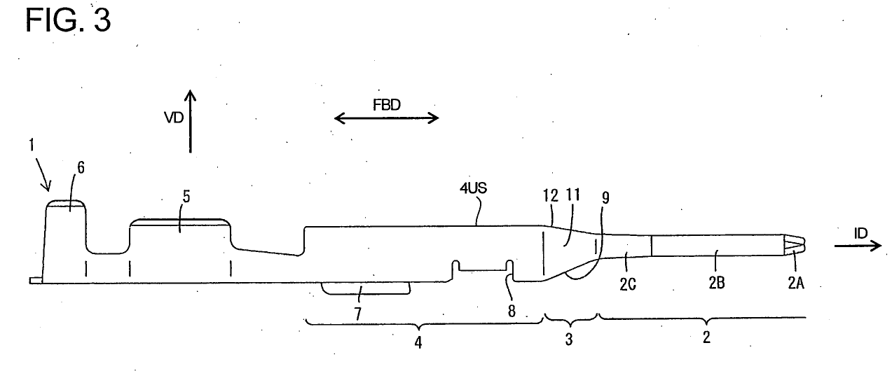

FIG. 4 is a front view of the male terminal fitting.

FIG. 5 is a right side view of a male terminal fitting according to a second embodiment.

FIG. 6 is a plan view of the male terminal fitting of FIG. 5.

FIG. 7 is a left side view of the male terminal fitting of FIG. 5.

FIG. 8 is a front view of the male terminal fitting of FIG. 5.

FIG. 9 is a plan view of a male terminal fitting of prior art.

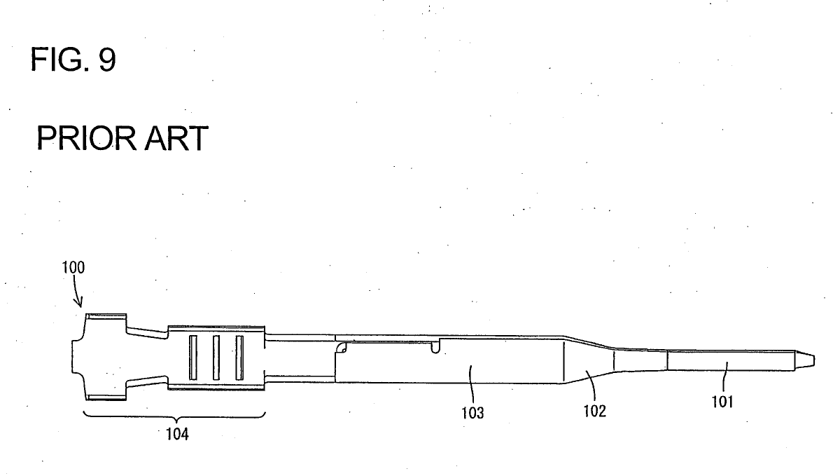

FIG. 10 is a development of the male terminal fitting according to the invention.

### DETAILED DESCRIPTION OF THE PREFERRED EMBODIMENTS

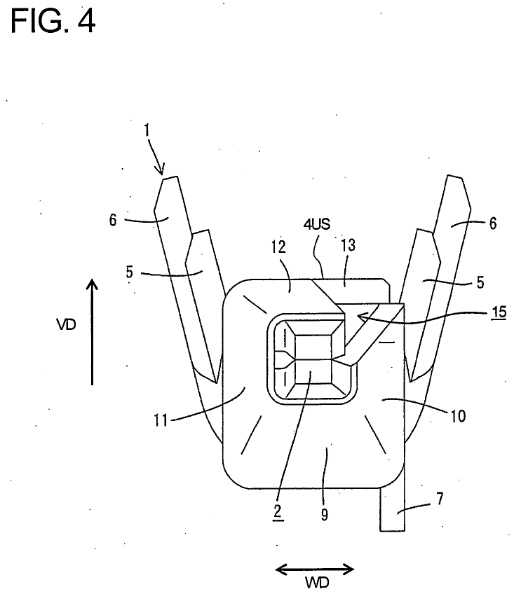

A male terminal fitting according to the invention is identified by the numeral 1 in the figures. The vertical direction VD described herein refers to the vertical orientation in FIG. 4, which is the direction in which the wire barrels 5 and 6 open. The width direction WD described herein refers to the transverse direction in FIG. 4, and the forward and backward directions FBD refer to a direction orthogonal to the plane of FIG. 4. A side of the male terminal fitting 1 that connects with a female terminal is referred to as the front.

The male terminal fitting 1 of the first embodiment is formed by bending a substantially flat conductive metal plate 1PM of a specified shape. The male terminal fitting 1 has an insulation barrel 6 that can be crimped, bent or folded into connection with an insulation coating of a wire W and a wire barrel 5 that can be crimped, bent or folded into connection with a conductive core exposed from the insulation coating. A substantially rectangular tube 4 is formed in an intermediate position of the male terminal fitting 1, and a contact 2 projects forward of the rectangular tube 4 via a link 3. Thus, the male terminal fitting 1 is substantially long along forward and backward directions FBD, and can be accommodated into a cavity of a connector housing (not shown).

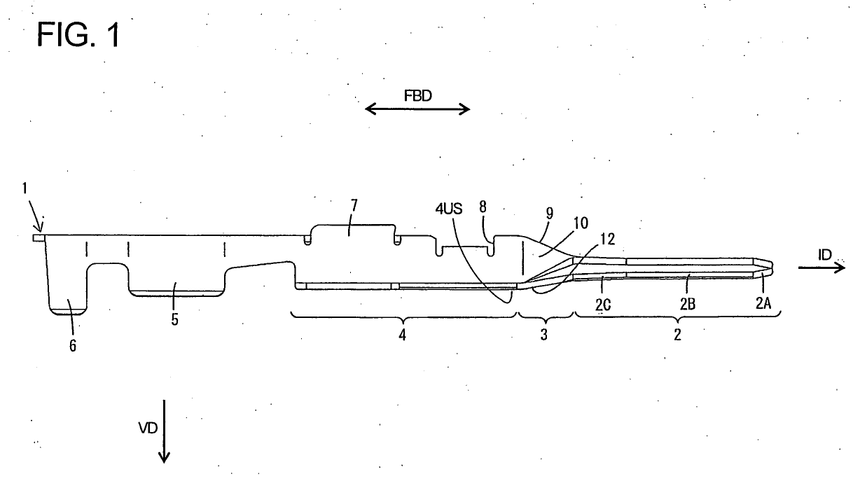

As shown in FIG. 1, an engaging portion 8 is formed at a front portion of the rectangular tube 4 and is engageable with a lock (not shown) provided in the cavity. Front and rear grooves are formed in an outer surface of the rectangular tube 4 to extend over substantially the entire width, and an area between the grooves is displaced inwardly to form a recess. The engaging portion 8 is the front one of these steps with respect to an inserting direction ID of the terminal fitting into the housing. A stabilizer 7 is provided at a rear portion of the rectangular tube 4 and is insertable into a guide groove (not shown) in the cavity The stabilizer 7 preferably is formed by making a cut in part of the bottom wall of the rectangular tube 4 and bending the cut portion. The stabilizer 7 can prevent an erroneous insertion such as an upside-down insertion of the male terminal fitting 1 in the cavity.

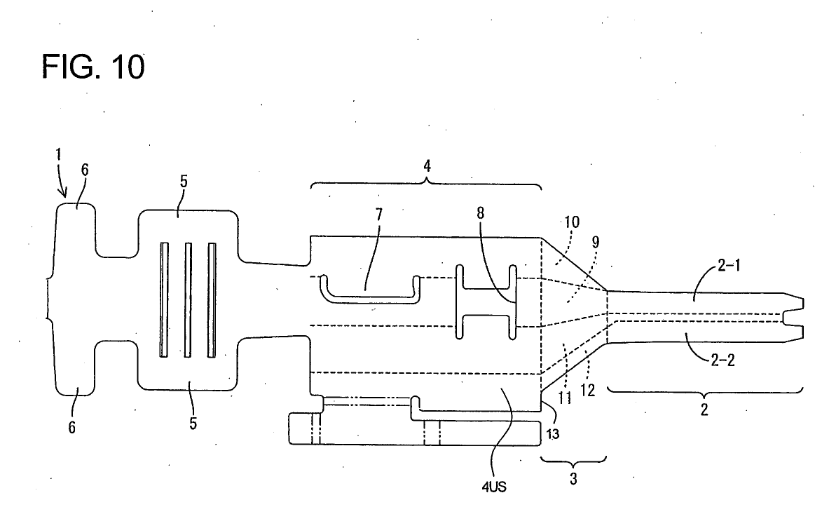

As shown in FIG. 10, the contact 2 has a lower plate 2-1 located substantially as an extension of the bottom surfaces of the barrels 5, 6 and an upper plate 2-2 substantially continuous with one lateral edge of the lower plate 2-1. The upper plate 2-2 is bent along a bending line shown in broken line in FIG. 10 and is placed on the lower plate 2-1 to form the contact 2. An introducing portion 2A is at the leading end of the contact and has closely held upper and lower parts. A principal portion 2B is substantially continuous with and behind the introducing portion 2A and defines a clearance of a uniform height between upper and lower plates. An inclined portion 2C is substantially continuous with and behind the principal portion 2B while defining a similar clearance and moderately slopes up and out towards the tube 4. As is clear from the drawings, the width and the vertical dimension of the contact 2 are smaller than the width and vertical dimension of the rectangular tube 4.

The link 3 includes a bottom wall 9 that extends substantially continuously from the lower plate 2-1 of the contact 2 and extending towards the rectangular tube 4. The bottom wall 9 has opposite first and second sides that gradually diverge from one another at locations closer to the rectangular tube 4. Thus, the bottom wall 9 is widened gradually towards the rectangular tube 4. First and second side walls 10, 11 extend up from the first and second opposite side edges of the bottom wall 9 and gradually widen to be continuous with the respective first and second side walls of the rectangular tube 4 at the front end of the rectangular tube 4. A ceiling wall 12 extends from the top of the first side wall 11 and hence is opposed to the bottom wall 9 of the link 3. The ceiling wall 12 has a front end that is continuous with the upper plate 2-2 and a rear end that is continuous with an upper wall 4US of the rectangular tube 4. Additionally, the ceiling wall 12 is aligned at an acute angle to the forward and backward directions FBD and hence at an acute angle to the longitudinal axis of the terminal fitting. Significantly, the ceiling wall 12 has a uniform width that is less than the maximum widths of the bottom wall 9 and the first and second side walls 10 and 11 at locations adjacent the rectangular tube 4. More particularly, the width of the rear end of the ceiling wall 12 is about half the width of the front end of the upper wall 4US of the rectangular tube 4. Thus, an unconnected edge 13 is defined at the front of the upper wall 4US of the rectangular tube 4. The unconnected edge 13 is adjacent to, but unconnected with the ceiling wall 12 of the link 3. Therefore, an opening 15 is formed in the link 3 by the unconnected edge 13, a side edge of the ceiling wall 12 and the upper edge of the second side wall 10.

The ceiling wall 12 of the link 3 is connected with only part of the front end of the upper wall 4US of the rectangular tube 4 to define the unconnected edge 13. Thus, the bending rigidity of the contact 2 is reduced, as compared to a case where the ceiling wall 12 is connected with the front end of the upper wall 4US of the rectangular tube 4 over the entire width without forming the unconnected edge 13, thereby improving the deflectability or bendability of the contact 2. Therefore, external forces on the contact 2 are not likely to produce a crack or the like due to the concentration of a stress and a deformation of the contact 2 resulting in a bend can be suppressed.

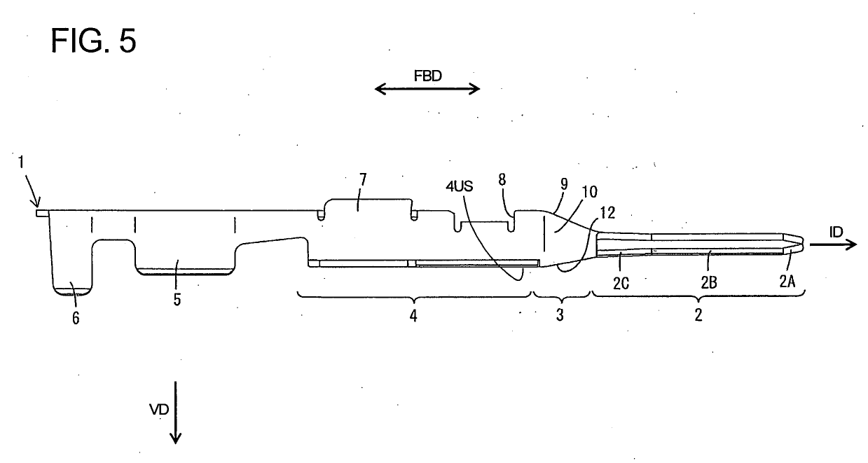

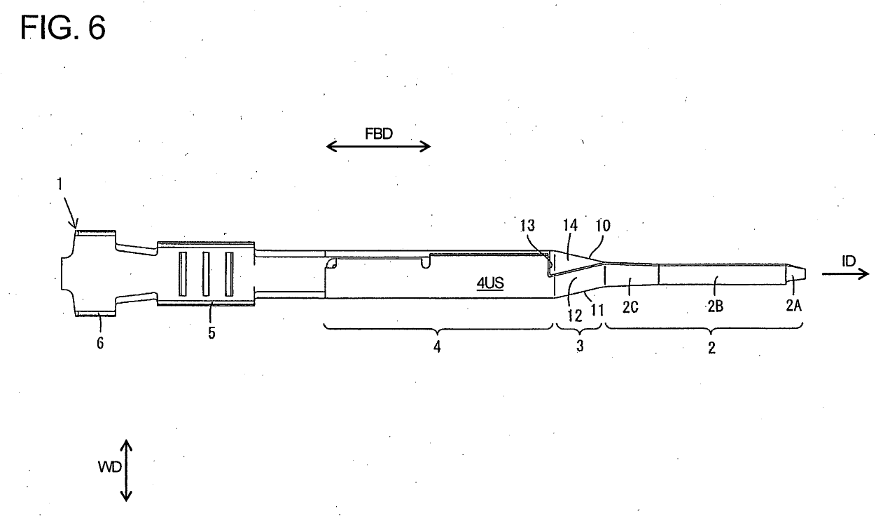

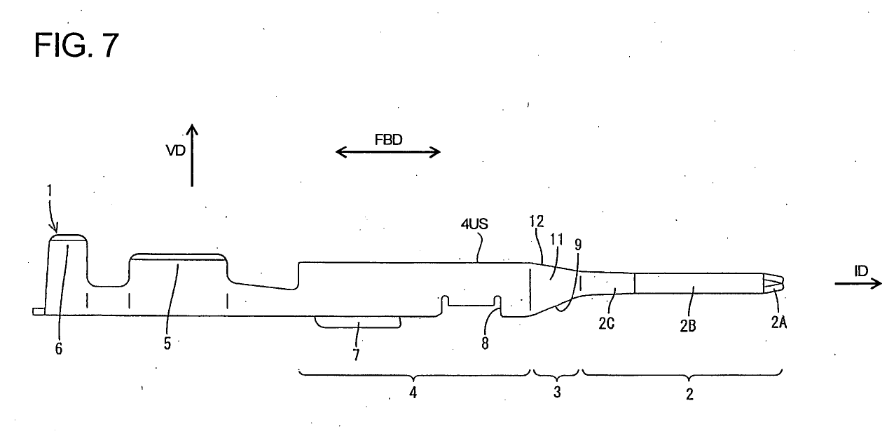

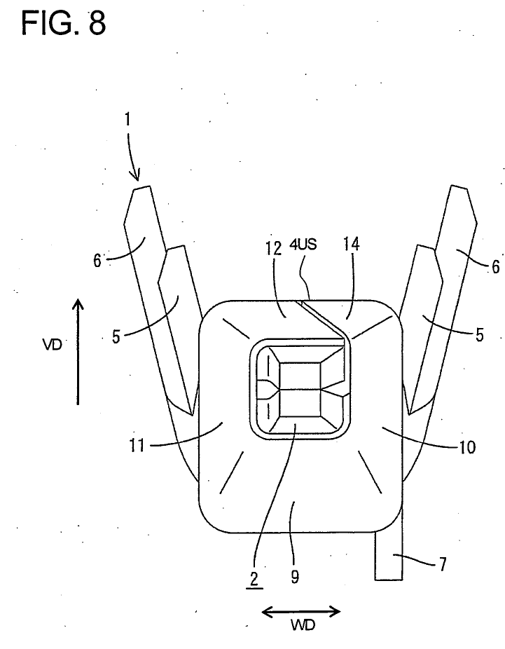

A second embodiment of the invention is described with reference to FIGS. 5 to 8. In the second embodiment, a closing plate 14 closes the opening 15 formed in the link 3 of the first embodiment is closed. The other construction is the same as or similar to the first embodiment. These similar parts are identified by the same reference numerals in FIGS. 5 to 8, but are not described again.

The closing plate 14 has a shape that substantially conforms to the shape of the opening 15 and is substantially continuous with the upper edge of the second side wall of the link 3 that is not connected with the ceiling wall 12. It should be noted that the second embodiment is the same as the first embodiment in that the front edge of the upper wall 4US of the rectangular tube 4 has the unconnected edge irrespective of whether the front edge is coupled to the closing plate 14.

As described above, the closing plate 14 of the second preferred embodiment, prevents external matter or the like from intruding into the link 3 or the rectangular tube 4 in addition to the effects of the first embodiment since no opening is left in the ceiling wall 12 of the link 3.

The invention is not limited to the above described and illustrated embodiments. For example, the following embodiment is also embraced by the technical scope of the present invention as defined by the claims. Beside the following embodiment, various changes can be made without departing from the scope and spirit of the present invention as defined by the claims.

The unconnected edge 13 is at a front of the upper wall of the rectangular tube 4 in the first and second embodiments. However, the unconnected edge 13 may be formed over substantially the entire width of the front edge of the upper wall of the rectangular tube 4.

The tube of the preferred embodiments has a substantially rectangular cross-section. However, the invention is equally applicable to tubes having other shapes, particularly substantially polygonal shapes (triangular, pentagonal, hexagonal, etc.).

The terminal fitting described above is connected to the wire by barrels. However, other means of connection may be used such as insulation displacement, soldering, (ultrasonic) welding, etc.

What is claimed is:

1. A male terminal fitting, comprising:
a contact (2) to be brought into contact with a female terminal fitting,
a tube (4) located behind the contact (2) and formed to be wider than the contact (2), and
a link (3) provided between the tube (4) and the contact (2) and gradually widened from the contact (2) towards the tube (4),
wherein:
the link (3) includes a base wall (9) substantially continuous with the contact (2) and the tube (4), one or more side walls (10; 11) substantially continuous with the contact (2) and the tube (4) and standing from the base wall (9), and a ceiling wall (12) substantially continuous with the contact (2) and extending rearwardly from the contact (2) towards the tube (4), and
the contact (2) having an inclined portion (2C) forward of and unitary with the link (3), the inclined portion (2C) tapering to smaller cross-sections at locations farther from the link (3), the contact (2) further having a principal portion (2B) of substantially uniform cross-sectional shape extending forward of the inclined portion (2C).

2. The male terminal fitting of claim 1, wherein the contact (2) includes an introducing portion (2A) extending unitarily from the principal portion (2B) to a front end of the terminal fitting (1), the introducing portion (2A) tapering to smaller cross-sectional dimensions at location farther forward from the principal portion (2B).

3. The male terminal fitting of claim 1, wherein the contact (2) includes lower and upper plates (2-1, 2-2) extending continuously from the link (3) to the front end of the terminal fitting (1).

4. The male terminal fitting of claim 3, wherein the lower and upper plates (2-1, 2-2) of the contact (2) are joined unitarily to one another along a fold area extending continuously along the inclined portion (2C) and the principal portion (2B).

5. The male terminal fitting of claim 4, wherein the lower and upper plates (2-1, 2-2) are opposed to one another along a height dimension and extend transversely from the fold area in a width direction, the inclined portion (2C) of the contact (2) tapering to smaller cross-sections at locations farther from the link (3) in the height direction.

6. The male terminal fitting of claim 5, wherein the inclined portion (2C) tapers to smaller cross-sections in the width direction at locations farther from the link (3).

7. The male terminal fitting of claim 1, wherein an unconnected edge (13) is formed at a front part of the of the tube (4) and unconnected with the ceiling wall (12) of the link (3).

8. The male terminal fitting of claim 1, wherein the tube (4) includes an engaging portion (8) engageable with a lock formed in a cavity of a connector housing when the male terminal fitting (1) is accommodated into the cavity.

9. The male terminal fitting of claim 1, wherein the ceiling wall (12) of the link (3) is bent from a first of the side walls (10) of the link (3) towards a second of the side walls (11) thereof or the base wall (9).

10. The male terminal fitting of claim 9, wherein the ceiling wall (12) and the contact (2) have substantially equal widths, and a rear end of the ceiling wall (12) is connected with a front part (4US) of the tube (4) substantially adjacent the unconnected edge (13).

11. The male terminal fitting of claim 1, wherein an opening (15) is defined adjacent to the unconnected edge (13), and the male terminal fitting (1) is formed with a closing plate (14) for at least partly closing the opening (15).
